(19) United States
(12) Patent Application Publication
(10) Pub. No.: US 2002/0194559 A1
(43) Pub. Date: Dec. 19, 2002

(54) Method for test-writing to the cell array of a semiconductor memory

(76) Inventors: Rupert Lukas, Munchen (DE); Manfred Proll, Dorfen (DE)

Correspondence Address: LERNER AND GREENBERG, P.A., Post Office Box 2480, Hollywood, FL, 33022-2480, US

(21) Appl. No.: 10/134,131

(22) Filed: Apr. 29, 2002

(30) Foreign Application Priority Data
Apr. 27, 2001 (DE) 101 20 761.1

(51) Int. Cl. G06F 11/263

(52) U.S. Cl. 714/720

(57) ABSTRACT

The cell array of a semiconductor memory, in particular of a DRAM, has word lines and bit lines, whose intersections define the cells of the cell array. A test data pattern is written to all the cells of a word line at the same time.

### BACKGROUND OF THE INVENTION

Field of the Invention

The invention lies in the semiconductor technology and memory technology fields. More specifically, the invention pertains to a method for test-by-test writing to the cell array of a semiconductor memory, in particular of a DRAM, which comprises word lines and bit lines, whose intersections define the cells of the cell array, using a test data pattern.

Semiconductor memories have a test data pattern written to them as standard in a test mode, in order to determine their serviceability and functionality, and in order to replace any defective cells by spare cells which are addressed instead, when the defective cells are addressed, during normal operation of the semiconductor memory.

In the prior art, the test-writing to the cell array of a semiconductor memory has been carried out word line by word line and cell for cell, that is to say by writing in serial form to each individual cell on a word line. This procedure is time-consuming, and thus results in increased production costs.

It is known for so-called bank interleaved patterns or burst patterns to be used to save time when writing in a conventional manner to the cell array of a semiconductor memory.

If a burst pattern is used, 2, 4, 8 etc., cells with different bit line addresses are written to sequentially stating only a bit line address as the burst start address. The number of cells which are written to in this way stating only a start address is referred to as the burst length n. A write signal in the burst mode accordingly leads to n writing processes, in which a bit line address is transferred as the burst start address with a write command. The write command must be followed by at least n-1 idle cycles, in order to allow the chip-internal generation of the n-1 write commands and the bit line addresses.

In the mode in which the bank interleaved pattern is used, the procedure is as follows: the independent control of banks within an SDRAM allows interleaving of the command sequences for the individual bank accesses. In comparison to sequential access to the banks, the bank interleaved pattern allows asynchronous timing patterns to be interleaved in a time-saving saving manner, which relate individually to the command sequences for the corresponding bank. This allows virtually continuous read/write access to the memory.

Although production can be carried out economically using this prior art test method, the same is nevertheless associated with high costs.

### SUMMARY OF THE INVENTION

It is accordingly an object of the invention to provide a method for test-writing to a cell field of a semiconductor memory device, which overcomes the above-mentioned disadvantages of the heretofore-known devices and methods of this general type and which ensures that a considerably greater amount of time is saved than in the past when writing to the cell array of a semiconductor memory.

With the foregoing and other objects in view there is provided, in accordance with the invention, a method for test-writing to a cell array of a semiconductor memory, in particular a DRAM, formed with word lines and bit lines, and memory cells defined at intersections between the word lines and the bit lines, the method which comprises writing a test data pattern to all of the cells along a word line at the same time.

In accordance with an added feature of the invention, the test data pattern is written to the entire cell array by addressing all the word lines of the cell array sequentially.

In accordance with a concomitant feature of the invention, the test data pattern is a bank interleaved pattern.

With the above and other objects in view there is also provided, in accordance with the invention, a circuit configuration for performing the above-outlined method. That is, there is provided, in a semiconductor memory having a cell array with bit lines, word lines, and memory cells defined at intersections between the word lines and the bit lines, a circuit for test-writing to the cell array of the semiconductor memory, comprising: a column decoder receiving a column activation signal (CAS); and a logic circuit receiving the column activation signal (CAS) and a test mode activation signal, the logic circuit being configured for a logic combination of the column activation signal with the test mode activation signal for simultaneously opening all the bit lines on a given word line.

While the previous methods of the type under discussion provide for time-consuming serial writing to each individual cell of a word line, the invention provides for all the cells of a word line to be written to in parallel. Since, according to the invention, the cells of a word line have test data patterns written to them at the same time, with this process being carried out word line by word line for the entire cell array, a considerable amount of time is saved in comparison to the previous method. In other words, the number of command cycles required for writing to the cell array can be reduced by several times, using the method carried out according to the invention. This makes it possible to reduce the so-called test data pattern delay time and hence the test time during production, in a corresponding manner. Since the test costs are a critical factor in the production costs, the invention makes it possible to make a major improvement to productivity of production of semiconductor memories.

The circuit designed according to the invention for carrying out the method according to the invention on the basis of a column activation signal for a column decoder of the semiconductor memory provides a logic circuit for logic combination of the column activation signal with a test mode activation signal for simultaneous opening of all the bit lines on a word line.

In order to optimize the shortening of the test time which can be achieved according to the invention, the bank interleaved pattern mentioned above is preferably used as the test data pattern.

Other features which are considered as characteristic for the invention are set forth in the appended claims.

Although the invention is illustrated and described herein as embodied in method for test-by-test writing to the cell array of a semiconductor memory, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a schematic diagram of a configuration for parallel actuation of all the bit lines of a word line for a semiconductor memory; and

FIG. 2 is a schematic diagram of the circuit of FIG. 1 in greater detail, in particular showing how the input data is fed in.

### DESCRIPTION OF THE PREFERRED EMBODIMENTS

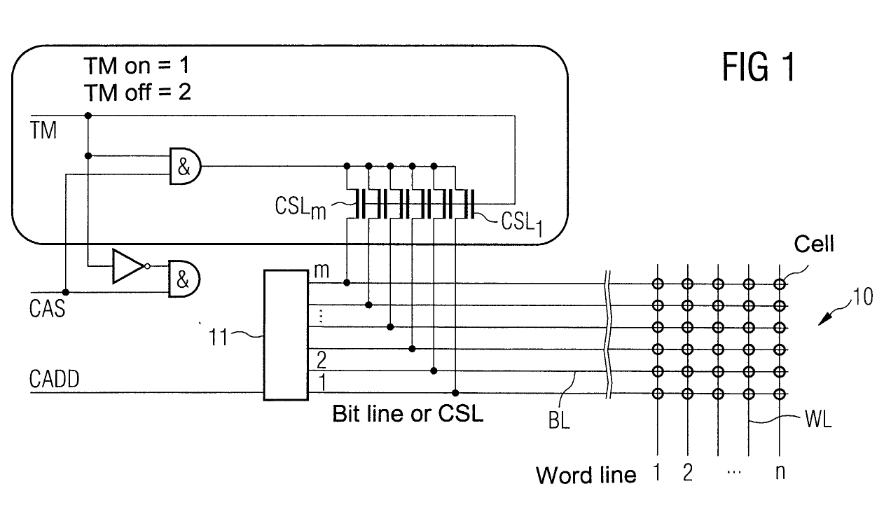

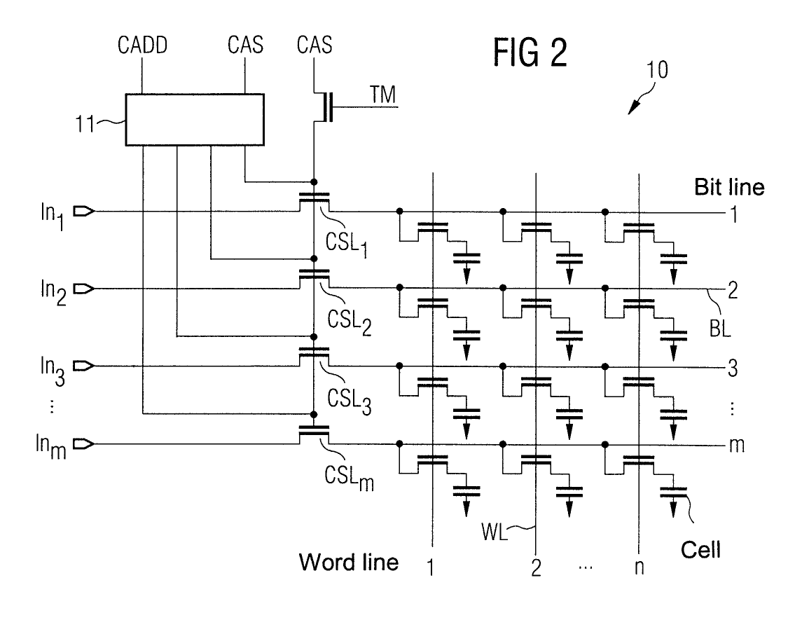

Referring now to the figures of the drawing in detail, there is shown a cell array on the right-hand part of the two figures that is annotated in general form by the reference number 10. The cell array comprises a number m bit lines, which are illustrated horizontally in FIGS. 1 and 2, and a number n word lines which are shown running vertically in the figures. One of the bit lines, namely the bit line 2, is annotated representatively by BL, and one of the word lines, namely the word line 2, is annotated representatively by WL.

The cells in the cell array 10 are fixed at the intersections of the bit lines with the word lines and are represented symbolically by circles in FIG. 1, while they are represented schematically in their transistor structure in FIG. 2.

FIG. 2 shows how the input signals are supplied to the cell array 10. Accordingly m input signals or input data items In₁ to Inₘ are applied to the m bit lines via m CSL gates or selection switches, which are annotated CSL₁ to CSLₘ in FIG. 2. The CSL gates CSL₁ to CSLₘ are actuated via a decoder circuit 11, which is itself actuated by a column address signal CADD and a column activation signal CAS.

According to the invention, the CSL gates CSL₁ to CSLₘ are also actuated via a test mode signal TM which, as can be seen from FIG. 1, is logically combined via an AND circuit with the CAS signal and is used to open all the bit lines of a word line 5 during a write cycle for writing a predetermined test data pattern to the cell array. All m bit lines BL in the region selected by the word line WL thus receive that logic data item which is predetermined via the IO of a test system, which is not illustrated in any more detail. All the rows of this word line WL thus at the same time receive the test data pattern defined by the IO. The data pattern can thus be written to the entire cell array 10 in n cycles by sequentially addressing all n word lines.

The shortening of the test time which is achieved in comparison to the prior art with the sequential writing process by writing to the cells of a word line simultaneously or in parallel can be optimized by using the bank interleaved pattern, as mentioned in the introduction, as the test data pattern. In contrast, a conventional pattern for writing to a cell array background requires m×n cycles.

We claim:

1. A method for test-writing to a cell array of a semiconductor memory formed with word lines and bit lines, and memory cells defined at intersections between the word lines and the bit lines, the method which comprises writing a test data pattern to all of the cells along a word line at the same time.

2. The method according to claim 1, which comprises writing the test data pattern to a DRAM.

3. The method according to claim 1, which comprises writing the test data pattern to the entire cell array by addressing all the word lines of the cell array sequentially.

4. The method according to claim 1, which comprises defining a bank interleaved pattern as the test data pattern.

5. In a semiconductor memory having a cell array with bit lines, word lines, and memory cells defined at intersections between the word lines and the bit lines, a circuit for test-writing to the cell array of the semiconductor memory, comprising:
a column decoder receiving a column activation signal;
a logic circuit receiving the column activation signal and a test mode activation signal, said logic circuit being configured for a logic combination of the column activation signal with the test mode activation signal for simultaneously opening all the bit lines on a given word line.
